(19) United States
(12) Patent Application Publication
(10) Pub. No.: US 2004/0117332 A1
(43) Pub. Date: Jun. 17, 2004

(54) Method and system for providing a combined metering and dispatching service with advertising

(76) Inventor: David N. Himebaugh, Pittsburgh, PA (US)

Correspondence Address: PAUL A. BECK & ASSOCIATES, SUITE 100, 1575 McFARLAND ROAD, PITTSBURGH, PA, 15216-1808, US

(21) Appl. No.: 10/292,721

(22) Filed: Nov. 12, 2002

(51) Int. Cl. G06F 17/00

(52) U.S. Cl. 705/417

(57) ABSTRACT

A system and method for providing a wireless Web-based dispatch, metering and tracking system for taxicabs and other fleets of mobile units for hire. The system accommodates on-line booking; various forms of payment; accurate and efficient metering, dispatch and reporting functions; and is supported by on-screen advertising.

### BACKGROUND OF THE INVENTION

1. Field of the Invention

The invention relates to a method and system used to provide a combined metering and dispatch service for mobile units and is used with on screen advertising located in the mobile unit. The mobile units are for hire, such as taxis and limousine services. The system uses wireless communication technology with a web server communicating with a computer processing unit in the mobile unit.

2. Related Art

Intelligent transportation systems for fleet management exist for an automated dispatch and metering of mobile units for hire. These systems are sometimes referred to as “telematics.” Current telematics systems use on-board and centralized computers, telecommunications devices, global positioning systems (GPS) and the Internet in combination or in single applications to assist fleet managers to monitor the location, condition, and performance of mobile units. In some cases, software applications are also incorporated to generate specialized reports related to the mobile unit's use.

Existing automated dispatch systems use a complex selection process to quickly and accurately assign drivers to new pick-up destinations based upon the know location of available mobile units and prioritized criteria determining mobile unit response. Most combine some type of global positioning system (GPS) to locate an available mobile unit, help determine routing, and in some cases, provide pertinent real-time information such as current traffic conditions.

Voice communication is used to convey an assignment to a driver or group of drivers by two-way radio, mobile pager, cellular telephone, trunked radio networks, microwave or other audio communication links. Once an assignment has been accepted and fulfilled, payment options exist for credit, debit, and pre-paid vouchers to be used as payment.

Currently, no single system combines dispatch and metering services with advertising to integrate the industry's best practices and technologies for efficient fleet management, safety and passenger satisfaction.

### BRIEF SUMMARY OF THE INVENTION

The invention uses existing GPS mapping software, dispatch logic, metering, and card reader technology and billing software but differs from these systems in significant ways:

(1) utilizes the Internet for booking and tracking reservations and paying invoices;

(2) a unique, mobile unit advertising interface transmits interactive advertising messages to passengers; and

(3) trip data is recorded and stored in a remote web server for report generation.

The invention combines a mobile unit fleet dispatch and metering system, along with driver and passenger interfaces. The system uses a computer processing unit located within the mobile unit and a remote web server to store, process, and report customer requests, mapping data, metering data, payment records, trip information and the like. Advertising is transmitted to the mobile unit's computer processing unit via Wi-FI (wireless Ethernet network) or via direct connection by using a data loader device.

The system for combined metering and dispatching service with advertising is comprised of a computer processing unit with touch-screen monitor interfaces for driver and passenger; software that provides multiple screen displays for various functions and data choices for driver and passenger; a means to request, receive and display global positioning navigational data transmitted to the computer processing unit; and a web server remote to the mobile unit and wirelessly coupled to the computer processing unit.

Most of the hardware components used by this system are based on original equipment manufacturer (OEM) versions of existing devices (circuit boards, printers, card readers, and the like).

All GPS mapping software likewise belongs to third-party companies. The method forms an invention which comprises: (1) the design of the integration software; (2) the design of the cases to house all circuits and user interfaces; (3) the passenger's interface allowing on-board/on-screen advertising and interactive directions to advertised businesses; and (4) the design of the integration hardware.

The unique Web interface allows transportation companies to easily manage their fleets by receiving and assigning reservations online via the Internet. Data collected during each trip, such as destination points and mileage, may be processed by the mobile unit's driver or by the transportation company. The system allows drivers and passengers to operate the system even if no Internet connection is available.

The invention improves the ease of booking a mobile unit for hire and general passenger experience by allowing customers to pay for their fares using an online system account, or in the mobile unit using cash, major credit, debit, or “smart” cards. The passenger interface means payment occurs without the need for handing the card to the driver. In addition to constant fare monitoring, the passenger's interface provides other useful information by displaying interactive advertising.

I provide a method to provide combined metering and dispatching which comprises receiving a request from a customer for a mobile unit with a driver to take the customer from an origination point to a destination point; storing the request in the form of request data in a web server which is remote from the mobile unit; providing a computer processing unit located in the mobile unit, the computer processing unit receives and processes: (i) the request data into request processed information; and (ii) metering data into metering information; transmitting the request data from the remote web server to the computer processing unit; and transmitting the request processed information and metering information from the computer processing unit to a driver interface module located in the mobile unit.

I provide a method to provide combined metering and dispatching service with advertising which incorporates the above and includes having the computer processing unit receiving and processing advertising data into advertising information and transmitting the advertising information from the computer processing unit to a passenger interface module located in the mobile unit.

I provide transmitting the metering information from the computer processing unit to the passenger interface module located in the mobile unit.

I provide that the computer processing unit receives and processes mapping data into mapping information which is transmitted from the computer processing unit to the driver interface module to enable the driver to take the customer from the origination point to the destination point.

I further provide transmitting the metering information from the computer processing unit to the remote web server for storing and further processing for any desired purpose. The passenger interface module has a payment function means to enable the customer to select different payment methods, the payment function means coupled to the computer processing unit and which creates data that is transmitted to a payment system for further processing. The driver interface module has a payment function means to enable the customer to select different payment methods, the payment function means coupled to the computer processing unit and which creates data that is transmitted to a payment system for further processing. The computer processing unit includes processing a record of the request processed information, the metering information and a payment, the record accessible at the driver interface module and the record transmitted to a system for storage and further processing. The computer processing unit further includes processing a record of the request processed information, the metering information and a payment, the record accessible at the passenger interface module and the record transmitted to a system for storage and further processing.

I further provide a system for use in providing a combined metering and dispatching service with advertising comprising a mobile unit for a driver and a passenger; a computer processing unit in the mobile unit; a first screen display in the mobile unit and coupled to the computer processing unit; a second screen display in the mobile unit and coupled to the computer processing unit; means transmitting global positioning navigational data to the computer processing unit; and a web server remote to the mobile unit and wirelessly coupled to the computer processing unit.

### BRIEF DESCRIPTION OF THE DRAWINGS

FIG. 1 is a flow diagram of the system according to the present invention.

FIG. 2 is a simplified illustration of the mobile unit's central processing unit and system according to the present invention.

FIG. 3 is a simplified diagram of the communications system according to the present invention.

FIG. 4 is a block diagram for the process of ordering, dispatching, and committing a mobile unit for hire according to the present invention.

FIG. 5 is a simplified block diagram for the process of (a) transferring and displaying data within the mobile unit; and (b) between the mobile unit's processor and the remote web server according to the present invention.

FIG. 6 shows mobile unit dispatching in the form of a block diagram.

FIG. 7 is a block diagram that shows the process of obtaining and completing a fare.

FIG. 8 is a diagram describing a system for providing combined metering, dispatching and advertising within a mobile unit for a driver and passenger.

### DETAILED DESCRIPTION OF A PREFERRED EMBODIMENT

### Definitions

Accessible at the driver interface module—Processed data available to the operator of a mobile unit.

Advertising—The activity of attracting public attention to a product or business, as by paid announcements in the broadcast, or electronic media.

Advertising data—Information, regarding advertising that is processed for different uses.

Advertising information—Processed advertising information for customer viewing.

Any desired purpose—Manipulating data at will.

Computer processing unit—The part of a computer that interprets and executes instructions.

Customer—Someone that buys and uses a service.

Data that is transmitted to a payment system for further processing—Information that is sent to a remote web server that manipulates data to approve payment for a service.

Destination point—A specific end point after a subsequent event.

Different payment methods—Multiple ways of processing transactions for a service.

Dispatching—The act of sending off, based on criteria, as to a specific destination.

Driver interface module—A screen for the operator of a mobile unit showing metering and other information.

First screen display—a screen that displays information to the driver.

Mapping data—A rule of correspondence established between a set that associates each element of a set with an element in the same or another set in the sense of geographical location.

Mapping information—Information derived from the mapping data to show instructions to the operator.

Means transmitting global positioning navigational data—a way to convey information about location being transmitted.

Metering—A device and method designed to measure time and distance to indicate, record and regulate an amount.

Metering data—Accumulating data based on time, distance and extras a mobile unit is for hire.

Metering information—Metering data in a form that is recorded, viewable and understandable.

Mobile unit—A mobile unit/vehicle for transportation.

Origination point—A beginning; a first part or stage of subsequent events with a specific location.

Passenger interface module—A screen for the customer showing metering and advertising information.

Payment function means—A device to let the customer pay by credit card, cash, account or other device, which includes, a card reader or touch screen or other wireless device.

Payment system—A way to pay by credit, cash, account, debit or other device to enable the customer to complete a transaction for a service or item by using banking procedures and the electronic systems for managing it.

Processing a record of the request-processed information—Reformatting already processed data for further data manipulation.

Record transmitted to a system for storage and further processing—Data from the mobile unit transferred to the remote web server for historical and further data manipulation.

Remote from the mobile unit—Not in a mobile unit.

Remote web server—A server process running at a web site that transmits out information in response to client requests from remote browsers that is not in a mobile unit.

Request—A formal message requesting a mobile unit or the like to a dispatcher.

Request data—Information supplied from a customer.

Request processed information—Information supplied by customer into specific format so to be distinguishable to the system and operator of the mobile unit.

Second screen display—a screen that displays information to a passenger.

Storing and further processing—Data that will be housed and converted to a certain format.

Storing the request data—Information supplied from a customer that will be housed in a web server or computer processing unit.

Mobile unit with a driver—A mobile unit for hire with someone to operate said mobile unit.

Transmitting—to send a signal by wire or wireless means.

Transmitting global positioning navigational data—information about location being transmitted.

Web server—A server process running at a web site that transmits out information in response to client requests from remote browsers.

Web server remote to the mobile unit and wirelessly coupled to the computer processing unit—a server not located in a mobile unit that is connected by cellular or some other type of radio frequency to the computer processing unit in the mobile unit.

### Description

The method includes an integrated system for simultaneously displaying metering, mapping and advertising to passengers and drivers in an easy to use format for mobile units for hire. The method includes the use of the Internet for online order processing, fleet management and reporting tools.

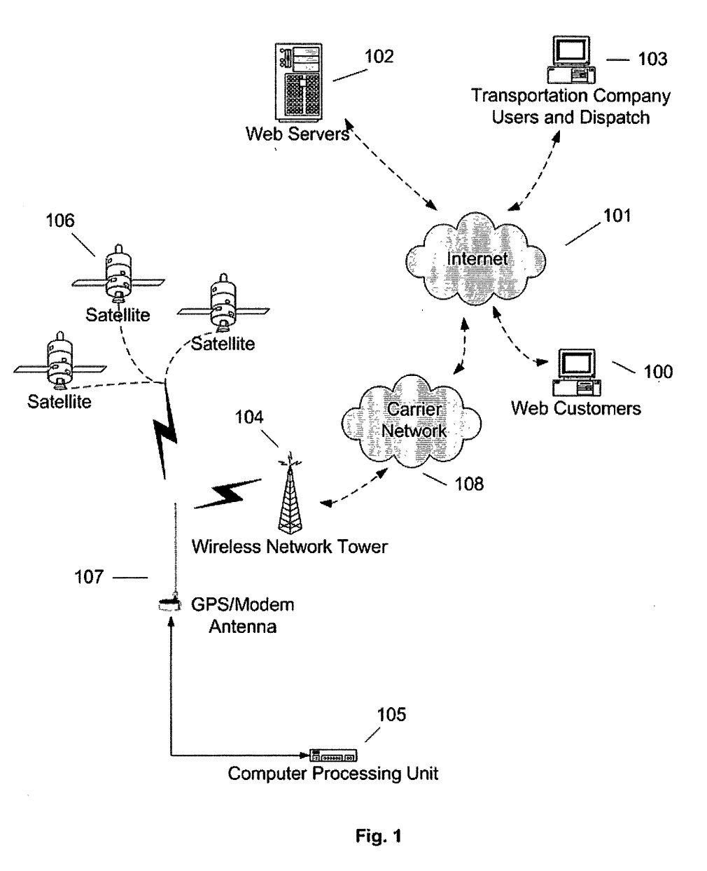

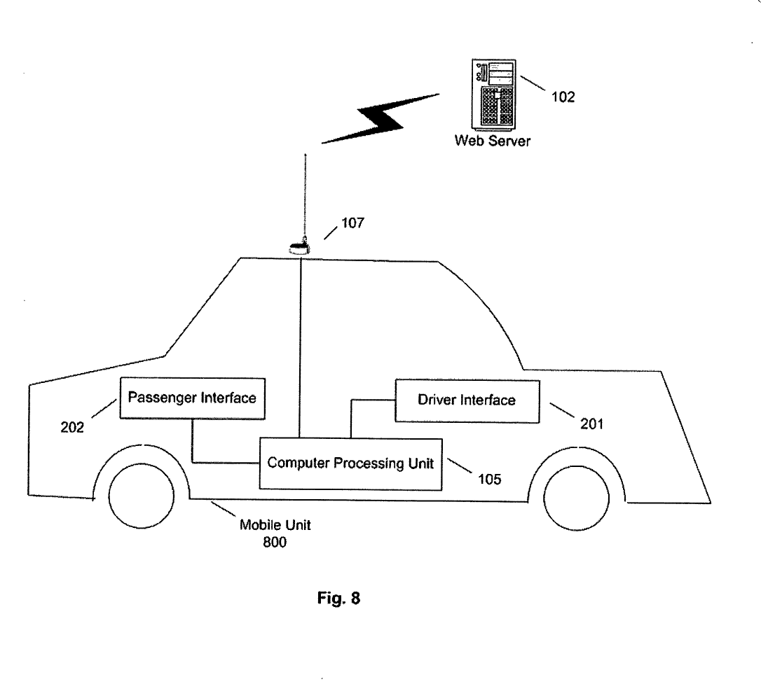

FIG. 1 illustrates the method in a system overview. The web customers 100 can order a mobile unit 800 (FIG. 8), such as a taxi or limousine. The system uses an Internet 101 and requires connections to remote web servers 102 where data is collected and processed. The information can then be accessed by a transportation company 103 to dispatch and retrieve data, such as personal data and an order request. Data is transmitted through a carrier network 108 by means of hard wire connection and sent by a wireless network 104 to certain mobile units 800 in the form of an order request. These orders are based on relative location to the pick up request, which means the taxi closest in proximity to the pick up location. Location is determined through a GPS system, which includes satellites 106, a GPS modem/antenna 107 and a computer-processing unit 105, which uses complex algorithms to pin point the closest mobile unit 800.

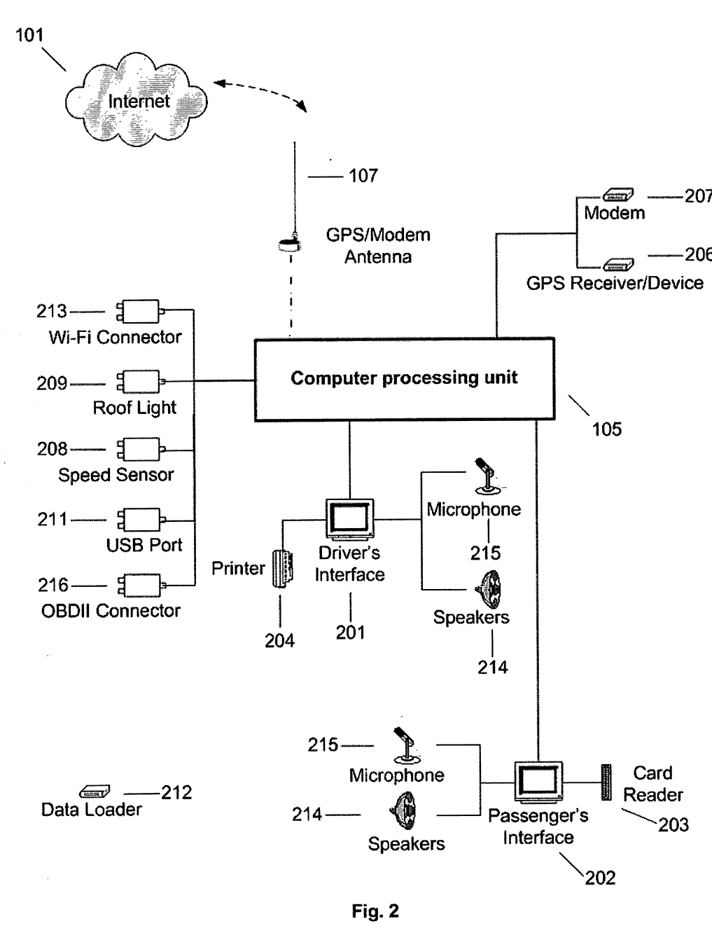

FIG. 2 shows a mobile unit 800 system in accordance with the method. A computer processing unit 105 is directly connected to all components that comprise the system that may include displays, sensors, and other apparatus. This device runs in an embedded version of an operating system that controls the functions of the system. A driver interface module 201 displays information such as pick up requests, metering information, mapping and driver menu options. These functions will help the driver of the mobile unit 800 in his everyday duties bringing greater efficiencies to the job. Connected to the driver interface module 201 is a printer 204 for providing receipts to a passenger, a microphone 215 and a speaker 214 are included to aid in directions and emergency situations. Passenger interface module 202 displays metering information, payment and language options, news information and advertisements to ease and aid the passengers during a trip. A card reader 203 is supplied for credit, debit and smart cards, which the passenger uses for convenience. The speaker 214 and the microphone 215 are also connected for security measures and emergency purposes to the passenger interface module 202. A GPS modem/antenna 107 is positioned externally on the mobile unit 800 and is used to transmit and receive: (i) data to aid in locating the mobile unit 800; and (ii) customer data in regards to pick up requests, payment confirmation and news information through the Internet 101. There is a GPS receiver/device 206 and a modem 207 integrated in the computer processing unit 105. The GPS keeps track of the actual position of the mobile unit 800, while the modem 207 is responsible for connecting the mobile unit 800 to the proper data network where it will manage the process of transmitting and receiving information.

In order for the metering function to operate it must be able to determine the distance of the mobile unit 800. In order to do that the computer processing unit 105 contains an interface to mobile unit 800 speed sensor 208, which is connected to the mobile unit 800 and calculates the mobile unit's 800 traveled distance by counting the number of pulses generated by the rotation of the mobile unit's 800 transmission axle. To monitor the mobile unit 800 even further, an OBDII (On-Board Diagnostic System) connector 216 is coupled to an on-board OBDII system to capture information provided by a mobile unit's 800 on-board diagnostic system in case the interface to the mobile unit's 800 speed sensor 208 is not available.

As with all taxis, a roof light sensor 209 is incorporated to let potential passengers know if the car is hired or vacant.

In regards to the transmission of the advertising to be viewed, downloading can be done in two different ways. The first is to transmit the information through the WI-FI connector 213 or a wired link with a data loader 212, which reads from a CD/DVD ROM that would be plugged into a USB port 211.

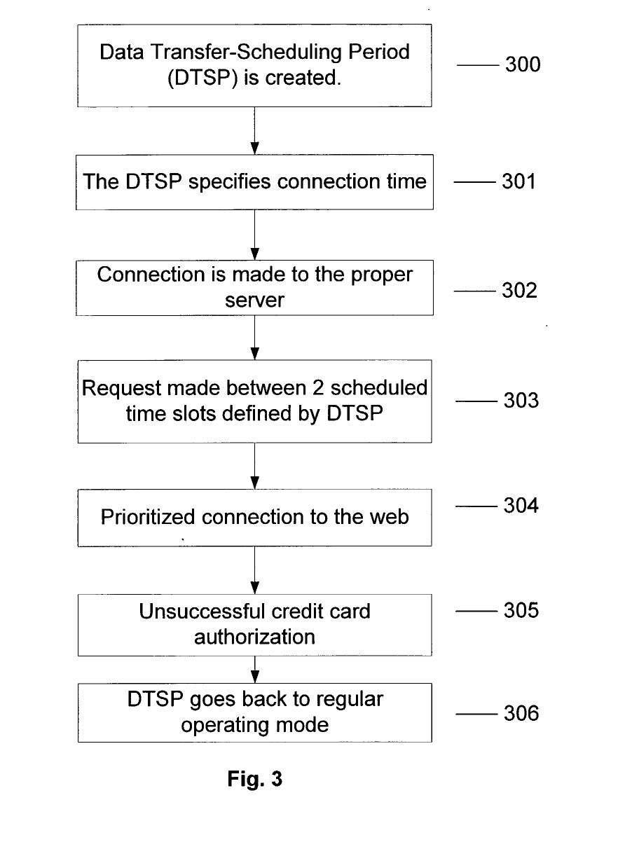

FIG. 3 is a block diagram referring to the method of data transfer in accordance with the method. A data transfer-scheduling period (DTSP) is created 300 which is a configuration file created and placed in the computer processing unit 105, which allows it to update itself and continue normal operations. This may include payment authorizations, emergency communications and predetermined communications. The DTSP specifies connection time 301 that previously determines times between mobile unit 800 and remote web server 102 connections or at specifically requested times. Once a connection is made to the proper server 302, data is brought in to the mobile unit 800 including: latest news feeds, order requests, and system configurations. The mobile unit 800 then may transmit data to the server 102, such as co ordinance and confirmations, which also use the connection.

While the system is running in regular operating mode, credit card transactions and pick up order acknowledgements might happen and a request made between two scheduled time slots defined by the DTSP 303 would be made. This would happen when a customer makes a request from the passenger interface module 202. If such an event were to take place, a prioritized connection to the web 304 is established immediately. If there is an unsuccessful credit card authorization 305 and it cannot be confirmed in real time, the authorization request is saved for later processing, when a proper connection is made. When the prioritized data transfer is complete, the DTSP goes back to regular operating mode 306, waiting for the next cycle (connection) to be initiated.

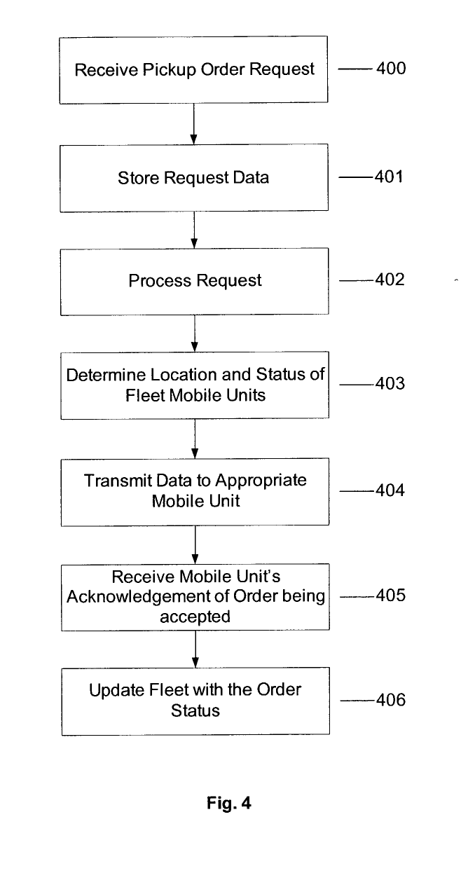

FIG. 4 is a block diagram showing the process of ordering, dispatching, and committing a mobile unit 800 for hire according to the invention. An order request 400 is initiated by phone or web order through the Internet 101 and comes from a customer for a pick up by a mobile unit 800. The request 400 is then converted to stored request data 401 on a remote web server 102 where it is then transformed into a processed request 402 that makes it an open ticket to be placed in a queue to be satisfied. A computer then determines location and status 403 of the most appropriate mobile unit 800 to respond, which also needs confirmation from a dispatcher. When this function is complete it then transmits data to the appropriate mobile unit 404. The mobile unit 800 operator acknowledges acceptance or rejection 405 and the remote web server 102 is then updated with order status 406 of the fleet.

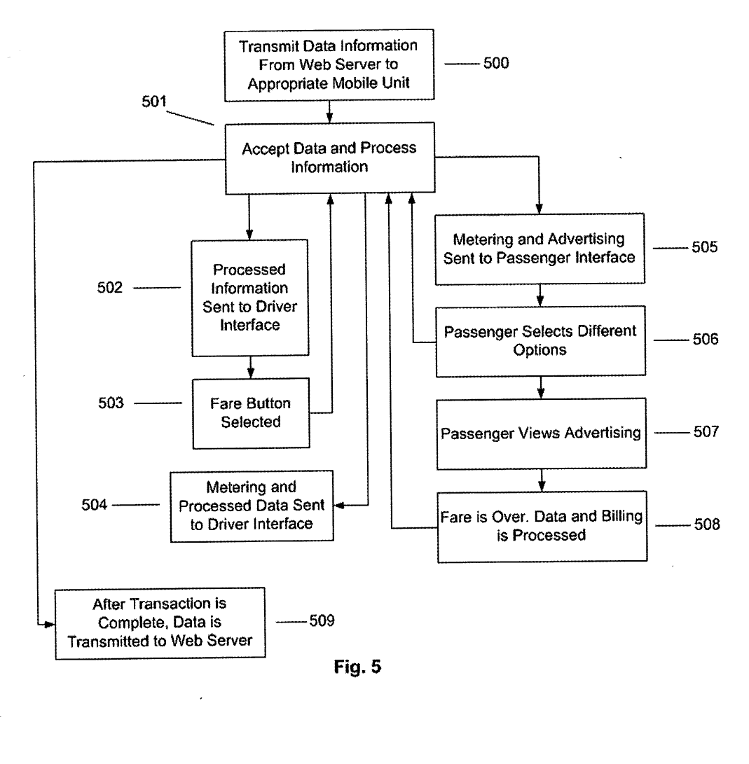

FIG. 5 portrays the main process of the system that resides in the mobile unit 800. Data and information are transmitted from a remote web server 102 to an appropriate mobile unit 500 and may take the form of an order request, payment verification, news information, mapping request or other types of information. The mobile unit 800 accepts (receives) and processes the information 501, which is either processed information sent to the driver interface 502 (such as a request pick up) or raw address information turned into a mapping solution by the mobile unit 800 computer processing unit 105. When a passenger has entered a mobile unit 800 the fare button is selected 503 and the request is then accepted and processed 501 and the metering and processed data is sent back to the driver interface 504. This would include metering and mapping solutions if coordinates are provided to the system. As other information is accepted and processed, portions may be directed to the passenger interface module 202 in the form of metering and advertising 505. When the process has started by the driver touching the fare button, the passenger gets to select different options 506 comprising different methods of how to pay and language options. For example, if a passenger is visiting from another country and is unfamiliar with the language the system will provide the same format but in their native language. After the passenger has completed his or her choices, multimedia advertising is displayed for his or her viewing 507, which includes video and audio clips with interactive options. When the fare is complete, data and billing are processed 508 and the transaction is transmitted to a remote web server 509 for further processing.

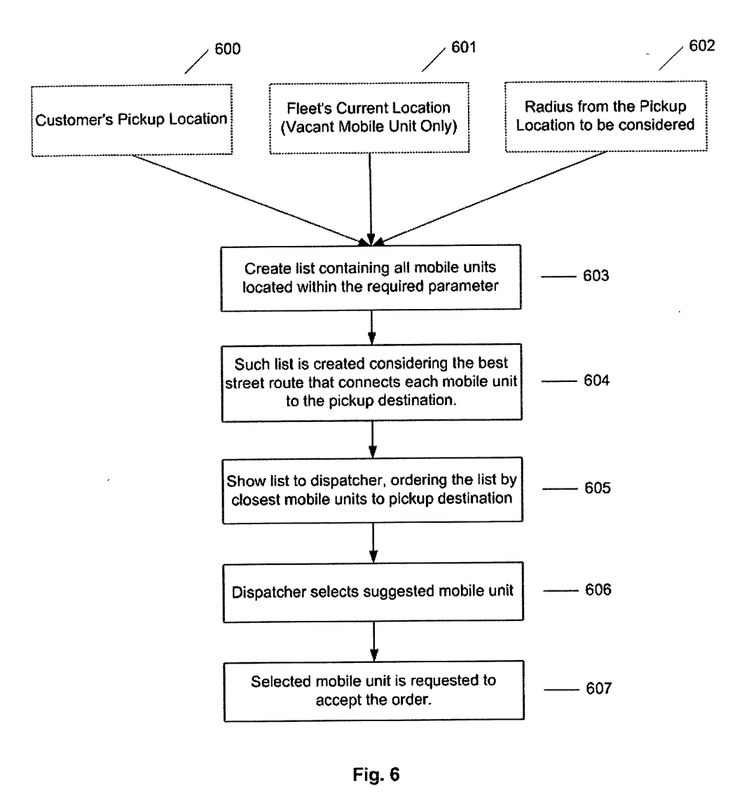

FIG. 6 shows mobile unit 800 dispatching in the form of a block diagram. In the dispatching of a mobile unit 800 there are certain elements that must be taken into consideration: 1) the customer's pick up location 600 is the physical address to where the customer is to be received; 2) the fleet's current location 601 as it refers to specific vacant mobile units 800 only; and 3) the radius from the pickup location to be considered 602 or the distance between a possible mobile unit 800 and its pickup location. When combined, the system creates a list containing all mobile units 800 located within the required parameters 603. This list is created considering the best street route that connects each mobile unit 800 to the pickup destination 604, because there may be several mobile units 800 appropriate to respond. The system then shows the list to the dispatcher, ordering the list by the closest mobile unit 800 to the pick up destination 605, which may be the quickest response time. The dispatcher then selects a suggested mobile unit 606 from the list based on information provided. The dispatcher may select another mobile unit 800 that may respond sooner because of an accident or other emergency that the computer may not be aware of. When the requested mobile unit 800 is selected, the driver of the selected mobile unit is requested to accept the order 607. Rejection of a pick up may be the result of an anticipated break or emergency for the driver.

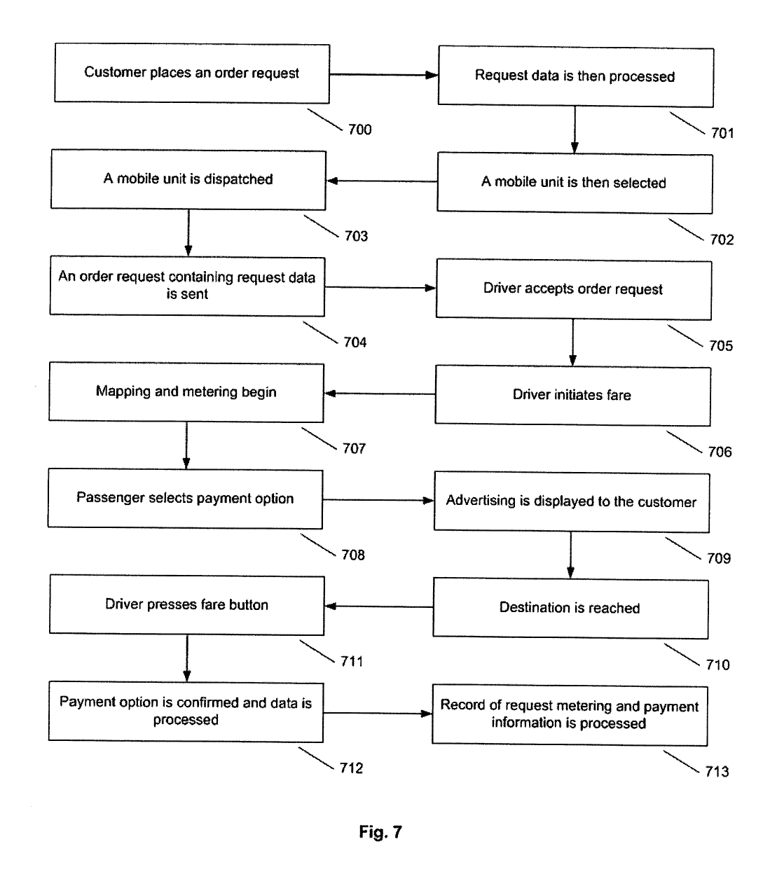

FIG. 7 and FIG. 8 provide a scenario for a customer/passenger trying to engage a mobile unit 800 for hire in a simple block diagram illustration in accordance with the present method. A customer places a request 700, for a taxi or limousine (mobile unit 800), through the Internet 101 or phone (the process is the same by phone only an operator would enter the information) by entering personal data such as name, phone number, pick up and destination points. This data is request data.

If ordered through the Internet 101 the request data is transmitted to a remote web server 102 and the request data is then processed 701 and stored in the remote web server 102. The requested processed data is then presented to the transportation company 103. When presented, a mobile unit 800 is then selected 702 and after selection has been initiated a mobile unit 800 is dispatched 703 and an order request containing request data is sent 704 to the computer processing unit 105 located in the mobile unit 800 by means of transmitting through the Internet 101, a carrier network 108 and wireless network tower 104. A decision is made as to which mobile unit 800 from a group of mobile units to select and to dispatch to the customer and aided by the remote web server 102 assisted by satellites 106, a GPS receiver/device 206, modem 207 and GPS modem/antenna 107. The remote web server 102 calculates an appropriate mobile unit 800 to respond based on its current location, relative to the pick up location. A Driver then accepts an order request 705.

At a pick up location the customer enters the mobile unit 800 and the driver initiates the fare 706 by hitting a fare button. At that time the mapping and metering starts 707. The order request resides in the computer processing unit 105 located in the mobile unit 800, which receives and processes mapping data into mapping information that is sent to the driver interface module 201 to aid in finding the destination of the passenger from an origination point. Simultaneously metering data is processed by the computer processing unit 105 located in the mobile unit 800 into metering information and is transmitted to the driver interface module 201. The metering data is gathered from a mobile unit 800-speed sensor 208.

The computer processing unit 105 located in the mobile unit 800 also transmits and displays the metering information to the passenger interface module 202. The passenger then selects payment options 708. At the passenger interface module 202 that has a payment function means, the passenger has the option to choose from credit, debit, smart card, account or cash. When a selection has been made, the computer processing unit 105 processes and creates data and transmits the data out wirelessly for payment authorization and data update to the appropriate remote web servers 102 and a payment system for then further processing.

After the passenger selects the payment option 708, advertising data, which is received in the computer processing unit 105 is processed into advertising information and is transmitted from the computer processing unit 105 to the passenger interface module 202 where the advertising is displayed to the customer 709.

When the destination is reached 710 the driver presses the fare button 711 on the driver interface module 201, which allows the passenger to continue or change payment options as well as add a tip and then the payment option is confirmed and data is processed 712. The record of request, metering and payment information is processed 713 in the computer processing unit 105 and transmitted to a remote web server 102 for further processing, storage and for any desired purpose. The record is also accessible to the driver at the driver interface module 201, which would give the driver instant access to pertinent data. Information including record of the request processed information; metering information and payment are accessible at the passenger interface module 202 that is pertinent to the passenger for their records.

FIG. 8 describes a system for providing combined metering, dispatching and advertising within a mobile unit 800 for a driver and passenger. Within the mobile unit 800 the computer processing unit 105 may be located underneath the dash, seat or any other place inconspicuous to a passenger.

A first screen display coupled to the computer processing unit 105, by wire or wireless technology, is in the driver interface module 201 mounted in such a way to make it ergonomically easy for the driver to view and use the display. A second screen display is in the mobile unit 800 and is coupled to the computer processing unit 105. Mounting would be completed in ways to accommodate the various interior layouts of the mobile unit 800 as to make it accessible and viewable to passengers.

A means transmitting global positioning navigational data to the computer processing unit 105 is done by hard wire with the aid of a GPS modem/antenna 107.

To complete the system a remote web server 102 which is remote to the mobile unit 800 and wirelessly coupled to the computer processing unit 105 via the GPS modem/antenna 107 is employed.

Various changes could be made in the above construction and method without departing from the scope of the invention as defined in the claims below. It is intended that all matter contained in the above description as shown in the accompanying drawings shall be interpreted as illustrative and not as a limitation.

I claim:

1. A method to provide combined metering and dispatching comprising:
(a) receiving a request from a customer for a mobile unit with a driver to take the customer from an origination point to a destination point;
(b) storing the request in the form of request data in a web server which is remote from the mobile unit;
(c) providing a computer processing unit located in the mobile unit, the computer processing unit receives and processes:
(i) the request data into request processed information; and
(ii) metering data into metering information;
(d) transmitting the request data from the remote web server to the computer processing unit; and
(e) transmitting the request processed information and the metering information from the computer processing unit to a driver interface module located in the mobile unit.

2. A method to provide combined metering and dispatching service with advertising comprising:
(a) receiving a request from a customer for a mobile unit with a driver to take the customer from an origination point to a destination point;
(b) storing the request in the form of request data in a remote web server which is remote from the mobile unit;
(c) providing a computer processing unit located in the mobile unit, the computer processing unit receives and processes:
(i) the request data into request processed information;
(ii) metering data into metering information; and
(iii) advertising data into advertising information;
(d) transmitting the request data from the remote web server to the computer processing unit;
(e) transmitting the request processed information and the metering information from the computer processing unit to a driver interface module located in the mobile unit; and
(f) transmitting the advertising information from the computer processing unit to a passenger interface module located in the mobile unit.

3. A method to provide combined metering and dispatching service with advertising as recited in claim 2 including transmitting the metering information from the computer processing unit to the passenger interface module located in the mobile unit.

4. A method to provide combined metering and dispatching service with advertising as recited in claim 2 wherein the computer processing unit receives and processes mapping data into mapping information which is transmitted from the computer processing unit to the driver interface module to enable the driver to take the customer from the origination point to the destination point.

5. A method to provide combined metering and dispatching service with advertising as recited in claim 2 including transmitting the metering information from the computer processing unit to the remote web server for storing and further processing for any desired purpose.

6. A method to provide combined metering and dispatching service with advertising as recited in claim 2 wherein the passenger interface module has a payment function means to enable the customer to select different payment methods, the payment function means coupled to the computer processing unit which creates data that is transmitted to a payment system for further processing.

7. A method to provide combined metering and dispatching service with advertising as recited in claim 2 wherein the driver interface module has a payment function means to enable the customer to select different payment methods, the payment function means coupled to the computer processing unit which creates data that is transmitted to a payment system for further processing.

8. A method to provide combined metering and dispatching service with advertising as recited in claim 2 wherein the computer processing unit includes processing a record of the request processed information, the metering information and a payment, the record accessible at the driver interface module, the record transmitted to a system for storage and further processing.

9. A method to provide combined metering and dispatching service with advertising as recited in claim 2 wherein the computer processing unit includes processing a record of the request processed information, the metering information and a payment, the record accessible at the passenger interface module, the record transmitted to a system for storage and further processing.

10. A system for use in providing a combined metering and dispatching service with advertising comprising:
(a) a mobile unit for a driver and a passenger;
(b) a computer processing unit in the mobile unit;
(c) a first screen display in the mobile unit and coupled to the computer processing unit;
(d) a second screen display in the mobile unit and coupled to the computer processing unit;
(e) means transmitting global positioning navigational data to the computer processing unit; and
(f) a web server remote to the mobile unit and wirelessly coupled to the computer processing unit.
